(19) United States
(12) Patent Application Publication
(10) Pub. No.: US 2018/0319714 A1
(43) Pub. Date: Nov. 8, 2018

(54) MICRO-CARBON BIO-FERTILIZER FOR RAPIDLY INCREASING SOIL GRANULAR STRUCTURE AND PREPARATION METHOD THEREOF

(71) Applicant: Mingqiang Zhang, Shanxi (CN)

(72) Inventor: Mingqiang Zhang, Shanxi (CN)

(21) Appl. No.: 15/773,768

(22) PCT Filed: Jun. 17, 2016
(86) PCT No.: PCT/CN2016/086122

§ 371 Date: May 4, 2018

(51) Int. Cl. C05F 7/00; C05F 17/00; C05G 3/04

(52) U.S. Cl. CPC C05F 7/005; C05G 3/04; C05F 17/0018

(57) ABSTRACT

A micro-carbon bio-fertilizer for rapidly increasing a soil granular structure and a preparation method thereof are provided. The formula composition of the micro-carbon bio-fertilizer by mass percentage is: 30-60% of micro carbons, and 40-70% of plant fibers. The preparation process includes is that: preparation of raw materials; filtration and purification of the raw materials; biodegradation; canning of semi-finished product; dispensing and mixing; sedimentation and achievement of finished product. The macromolecular carbohydrates contained in the industrial wastewater rich in organic matters are activated into micro carbons of 100 μm in average through biotechnologies. The micro carbons have natural affinity with soil and split the soil into small particles which are gathered to form a granular structure. Such a granular structure mitigates the degree of soil hardening and acidification, while quickly increasing soil fertility and improving crop quality and yield.

### CROSS-REFERENCE TO RELATED APPLICATION

This application is a national phase entry of, and claims priority to, International Application No. PCT/CN2016/086122, filed Jun. 17, 2016, with the same title as listed above. The above-mentioned patent application is incorporated herein by reference in its entirety.

### TECHNICAL FIELD

The present invention relates to the technical field of bio-fertilizer preparation, and in particular, to a micro-carbon bio-fertilizer for rapidly increasing a soil granular structure and a preparation method thereof.

### BACKGROUND

The soil granular structure is a type of soil structure in which several soil simple grains are bonded together to form an aggregate. Since small pores are formed between the simple grains and large pores are formed between the aggregates, the total porosity of the soil granule structure is larger than that of a simple-grain structure. The small pores can retain moisture, while the large pores maintain ventilation, and the soil having a good granule structure can ensure good growth of plant roots and thus is suitable for crop cultivation.

The soil particles are bound into a colloid by an organic matters, water, microorganisms and secretions thereof. During the course that the microorganisms decompose the organic matter into micro carbons having a diameter of about 100 μm, the soil colloid is split up into small particles; and the micro carbons are finally decomposed by the microorganisms to release carbon dioxide and water. The discharge of carbon dioxide, the surface tension of water and the gravity make these small particles be presented as a loose and porous cylinder or sphere (like a steamed bun or a steamed sponge cake, a bread, etc.). Multiple small particles are naturally gathered to form an aggregate for water retention, heat preservation, fertilizer retention, and air permeability, thereby together forming a granular structure to create a comfortable living environment for the root system. The soil defines a good granular structure that is loose and air-permeable, and thus the plants grown therein have a robust root system, and the harvested vegetables and fruits have fragrant and sweet tastes.

When the soil is rich in micro carbons, a chemical fertilizer functions to increase production; while when the soil has insufficient micro carbons, the chemical fertilizer accelerates the potential “collapse” of the granules, and thus the soil is hardened and acidified, such that the root system may die due to soil hypoxia, and a fertile farmland will become a barren desert. Accordingly, it would be desirable to provide a fertilizer or process for assuring soil is rich in micro carbons with an increased granular structure.

### SUMMARY

To solve the above problem, the present invention provides a micro-carbon bio-fertilizer for rapidly increasing a soil granular structure and a preparation method thereof. The micro-carbon bio-fertilizer mitigates the degree of soil hardening and acidification and quickly increases soil fertility to avoid the “collapse” or hardening of soil granules as caused by application of excessive amounts of chemical fertilizers, while increasing fertilizer efficiency and improving crop quality and yield.

To achieve the above object, the present invention according to one embodiment provides a micro-carbon bio-fertilizer for rapidly increasing a soil granular structure, the formula composition of which by mass percentage is: 30-60% of micro carbons, and 40-70% of plant fibers.

Furthermore, the particle size of the micro carbon is preferably 100 μm in average.

Furthermore, the particle size of the plant fiber is preferably 80 mesh.

The present invention also provides according to another embodiment a method for preparing a micro-carbon bio-fertilizer for rapidly increasing soil granular structure. The method includes the steps of: (1) preparation of raw materials: industrial wastewater rich in organic matters and plant stems, which both should meet standards for grains; (2) filtration and purification of the industrial wastewater: the aforementioned industrial wastewater is filtered and purified according to production requirements; (3) smash of the plant stems: the plant stems are smashed into 80-mesh powder according to process requirements; (4) biodegradation: active yeast strains are added in proportion into the purified industrial wastewater as mentioned above, sealed and fermented, and degraded into micro carbons; (5) canning of semi-finished product: the micro carbons of 100 μm are extracted according to quality standards, and then stored in a can; (6) dispensing and mixing: the powder of plant stems is thoroughly mixed with the aforementioned micro carbons in proportion; (7) weighing and packaging: the mixture is weighed automatically and then packaged; (8) detection: detection is performed for foreign materials such as a metal, so as to remove an unqualified product; and (9) finished product: the finished product is put in storage.

The present invention achieves several technical effects and advantages. In the present invention, the macromolecular carbohydrates contained in the industrial wastewater rich in organic matters are activated into micro carbons of 100 μm in average through biotechnologies. The micro carbons have natural affinity with soil and split the soil into small particles which are gathered to form a granular structure. Such a granular structure mitigates the degree of soil hardening and acidification to avoid the “collapse” of soil granules as caused by application of excessive amounts of chemical fertilizers, while quickly increasing soil fertility and improving crop quality and yield.

### DETAILED DESCRIPTION

Various additional features and advantages of the invention will become more apparent to those of ordinary skill in the art upon review of the following detailed description of one or more illustrative embodiments. To this end, although no drawings are included with this application, the above and other technical features and advantages of the present invention will be described in more details in connection with the following embodiments.

### Embodiment 1

The micro-carbon bio-fertilizer according to this embodiment defines a formula composition of 30% of micro carbons having a particle size of 100 μm, and 70% of hemp fibers having a particle size of 80 mesh.

The method of preparing the micro-carbon bio-fertilizer of this embodiment includes the following steps:
(1) raw materials: industrial wastewater rich in organic matters (molasses, yeasts, wine, etc.) and hemp stems, which both should meet standards for grains;
(2) filtration and purification of the industrial wastewater: the aforementioned industrial wastewater is filtered and purified according to production requirements;
(3) smash of hemp stems: the hemp stems are smashed into 80-mesh powder according to process requirements;
(4) biodegradation: active yeast strains are added in proportion into the purified industrial wastewater as mentioned above, sealed and fermented, and degraded into micro carbons;
(5) canning of semi-finished product: the micro carbons of 100 μm are extracted according to quality standards, and then stored in a can;
(6) dispensing and mixing: the powder of hemp stems is thoroughly mixed with the aforementioned micro carbons in proportion;
(7) weighing and packaging: the mixture is weighed automatically and then packaged;
(8) detection: detection is performed for foreign materials such as a metal, so as to remove an unqualified product; and
(9) finished product: the finished product is put in storage.

### Embodiment 2

The micro-carbon bio-fertilizer according to this embodiment defines a formula composition of 45% of micro carbons having a particle size of 100 μm, and 55% of tobacco fibers having a particle size of 80 mesh.

The method of preparing the micro-carbon bio-fertilizer of this embodiment includes the following steps:
(1) raw materials: industrial wastewater rich in organic matters (molasses, yeasts, wine, etc.) and tobacco stems, which both should meet standards for grains;
(2) filtration and purification of the industrial wastewater: the aforementioned industrial wastewater is filtered and purified according to production requirements;
(3) smash of tobacco stems: the tobacco stems are smashed into 80-mesh powder according to process requirements;
(4) biodegradation: active yeast strains are added in proportion into the purified industrial wastewater as mentioned above, sealed and fermented, and degraded into micro carbons;
(5) canning of semi-finished product: the micro carbons of 100 μm are extracted according to quality standards, and then stored in a can;
(6) dispensing and mixing: the powder of hemp stems is thoroughly mixed with the aforementioned micro carbons in proportion;
(7) weighing and packaging: the mixture is weighed automatically and then packaged;
(8) detection: detection is performed for foreign materials such as a metal, so as to remove an unqualified product; and
(9) finished product: the finished product is put in storage.

### Embodiment 3

The micro-carbon bio-fertilizer according to this embodiment defines a formula composition of 60% of micro carbons having a particle size of 100 μm, and 55% of flax fibers having a particle size of 80 mesh.

The method of preparing the micro-carbon bio-fertilizer of this embodiment includes the following steps:
(1) raw materials: industrial wastewater rich in organic matters (molasses, yeasts, wine, etc.) and flax stems, which both should meet standards for grains;
(2) filtration and purification of the industrial wastewater: the aforementioned industrial wastewater is filtered and purified according to production requirements;
(3) smash of flax stems: the flax stems are smashed into 80-mesh powder according to process requirements;
(4) biodegradation: active yeast strains are added in proportion into the purified industrial wastewater as mentioned above, sealed and fermented, and degraded into micro carbons;
(5) canning of semi-finished product: the micro carbons of 100 μm are extracted according to quality standards, and then stored in a can;
(6) dispensing and mixing: the powder of hemp stems is thoroughly mixed with the aforementioned micro carbons in proportion;
(7) weighing and packaging: the mixture is weighed automatically and then packaged;
(8) detection: detection is performed for foreign materials such as a metal, so as to remove an unqualified product; and
(9) finished product: the finished product is put in storage.

In the present invention, the macromolecular carbohydrates contained in the industrial wastewater rich in organic matters are activated into micro carbons of 100 μm in average through biotechnologies. The micro carbons have natural affinity with soil and split the soil into small particles which are gathered to form a granular structure. Such a granular structure mitigates the degree of soil hardening and acidification to avoid the “collapse” of soil granules as caused by application of excessive amounts of chemical fertilizers, while quickly increasing soil fertility and improving crop quality and yield.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention

What is claimed is:

1. A micro-carbon bio-fertilizer for rapidly increasing a soil granular structure, wherein a formula composition of the micro-carbon bio-fertilizer by mass percentage is:
30-60% of micro carbons, and
40-70% of plant fibers.

2. The micro-carbon bio-fertilizer of claim 1, wherein an average particle size of the micro carbons is 100 μm.

3. The micro-carbon bio-fertilizer of claim 1, wherein a particle size of the plant fibers is 80 mesh.

4. A method for preparing a micro-carbon bio-fertilizer for rapidly increasing a soil granular structure comprising the steps of:
(1) preparing of raw materials, including industrial wastewater rich in organic matters and plant stems;
(2) filtering and purifying the industrial wastewater according to production requirements;
(3) smashing of the plant stems into 80-mesh powder according to process requirements;
(4) conducting biodegradation by adding active yeast strains in proportion into the purified industrial wastewater, and then sealing and fermenting the yeast strains and industrial wastewater, resulting in degradation into micro carbons;
(5) extracting the micro carbons of 100 μm, and then canning the micro carbons to be stored in a can;
(6) mixing the powder of plant stems with the micro carbons in proportion to form a mixture;
(7) weighing and packaging the mixture automatically;
(8) detecting of any foreign materials such as a metal in the mixture, to remove any unqualified product containing any foreign materials; and
(9) storing finished product.

5. The method of claim 4, wherein the mixture formed in step (6) includes a formula composition by mass percentage of:
30-60% of the micro carbons, and
40-70% of the plant stems.

6. The method of claim 5, wherein the plant stems include hemp fibers, and the mixture formed in step (6) includes a formula composition by mass percentage of:
30% of the micro carbons, and
70% of the hemp fibers.

7. The method of claim 5, wherein the plant stems include tobacco fibers, and the mixture formed in step (6) includes a formula composition by mass percentage of:
45% of the micro carbons, and
55% of the tobacco fibers.

8. The method of claim 5, wherein the plant stems include flax fibers, and the mixture formed in step (6) includes a formula composition by mass percentage of:
60% of the micro carbons, and
40% of the flax fibers.

9. The micro-carbon bio-fertilizer of claim 1, wherein the plant fibers include hemp fibers, and the formula composition by mass percentage is:
30% of the micro carbons, and
70% of the hemp fibers.

10. The micro-carbon bio-fertilizer of claim 1, wherein the plant fibers include tobacco fibers, and the formula composition by mass percentage is:
45% of the micro carbons, and
55% of the tobacco fibers.

11. The micro-carbon bio-fertilizer of claim 1, wherein the plant fibers include flax fibers, and the formula composition by mass percentage is:
60% of the micro carbons, and
40% of the flax fibers.
